(19) United States
(12) Patent Application Publication
(10) Pub. No.: US 2020/0142618 A1
(43) Pub. Date: May 7, 2020

(54) CABINET SERVER SYSTEM AND SERVER

(71) Applicants: INVENTEC (PUDONG) TECHNOLOGY CORPORATION, Shanghai City (CN); INVENTEC CORPORATION, Taipei City (TW)

(72) Inventor: Peng ZHAN, Shanghai City (CN)

(73) Assignees: INVENTEC (PUDONG) TECHNOLOGY CORPORATION, Shanghai City (CN); INVENTEC CORPORATION, Taipei City (TW)

(21) Appl. No.: 16/217,713

(22) Filed: Dec. 12, 2018

(30) Foreign Application Priority Data
Nov. 6, 2018 (CN) 201811313551.8

(51) Int. Cl. G06F 3/06; G06F 13/16; G06F 13/40

(52) U.S. Cl. CPC G06F 3/0631; G06F 3/0604; G06F 13/4022; G06F 13/1668; G06F 3/0683

(57) ABSTRACT

The present disclosure relates to a cabinet server system, comprising a plurality of storage nodes and a plurality of calculation nodes. At least one serial storage signal switch node, respectively connected to the plurality of calculation nodes and the plurality of storage node, allocated to arrange the calculation node and the storage node. The present disclosure allocates a calculation node and a storage node through a serial storage signal switch node, and has a flexible configuration. Each calculation node can randomly allocate the number of hard disks according to service requirements, and the hard disks on each calculation node can be evenly allocated to multiple storage nodes to achieve load balancing while ensuring the security of the system data. Also, in the present disclosure, a single storage node can connect to the calculation nodes through two serial storage signal switch nodes, and when one path is not functioning, the hard disks on the storage node can still be accessed.

### CROSS-REFERENCE TO RELATED APPLICATIONS

This non-provisional application claims priority under 35 U.S.C. § 119(a) on Patent Application No(s). 201811313551.8 filed in China on Nov. 6, 2018, the entire contents of which are hereby incorporated by reference.

### BACKGROUND

### 1. Technical Field

The present disclosure relates to the field of server technologies, and particularly to the field of network remote access technologies, and more particularly to a cabinet server system and a server.

### 2. Related Art

In the era of intelligent internet, internet data is exploding in a geometrical scale. How to store and manage such massive data is a problem faced by many companies. When using the traditional general-purpose server storage strategy is adopted, building a huge data center system is needed, resulting in a rapid increase in storage costs.

For those cloud service providers, a large amount of constantly growing data such as images are infrequently accessed, but they cannot be deleted. Even if the customer does not access the information for a long time, they cannot delete it by will and the archive is not allowed to be stopped. It is also impossible to do flood peak data control. For these infrequently accessed “cold” materials, if we can migrate them to a low-cost storage layer designed for cold data, it will significantly reduce the costs.

Cold storage is primarily used in applications such as backup, disaster recovery, data saving, and social media. These materials all have the following common features, which are a low frequency of access, the need of minimizing their storage costs, and accessibility at all times. For example, a large amount of image information stored by users on social media, or legal electronic forensics requirements, must be archived for a specific time frame. Therefore, this requires cloud service providers and companies to ensure the completion of the data, as well as timely access rights.

There are not many cabinets for cold storage servers in the market. Only those of the type with a point-to-point connection topology between the calculation nodes and the storage nodes are available. However, it is not good at expansion, and not good at data security either.

### SUMMARY

In view of the above disadvantages of the prior art, the subject of the present disclosure is to provide a cabinet server system and a server for solving the disadvantage of inflexible cold storage configuration in the prior art.

To complete the above and other related subjects, the present disclosure provides a cabinet server system, the cabinet server system includes: a plurality of storage nodes and a plurality of calculation nodes; at least one serial storage signal switch node, respectively connected to the plurality of calculation nodes and the plurality of storage nodes, allocated to arrange the calculation node and the storage node.

In an embodiment of the present disclosure, the serial storage signal switch node includes a first serial storage signal switch node and a second serial storage signal switch node; the first serial storage signal switch node is respectively connected to the plurality of storage node and the plurality of calculation nodes, and the second serial storage signal switch node is respectively connected to the plurality of storage nodes and the plurality of calculation nodes.

In an embodiment of the present disclosure, the plurality of storage nodes is respectively connected to the first serial storage signal switch node and the second serial storage signal switch node through a dual interface data line; the plurality of calculation nodes is respectively connected to the first serial storage signal switch node and the second serial storage signal switch node through a dual interface data line.

In an embodiment of the present disclosure, the allocation of the calculation nodes and the storage node comprises: one or a plurality of hard disks of the storage node which is allocated for any one of the calculation nodes.

In an embodiment of the present disclosure, the allocation of the calculation nodes and the storage node comprises: a plurality of hard disks in the plurality of storage nodes which is allocated for one of the calculation nodes.

In an embodiment of the present disclosure, the allocation of the calculation node and the storage node comprises: a plurality of hard disks under the plurality of calculation nodes allocated to a plurality of the storage nodes.

In an embodiment of the present disclosure, the serial storage signal switch node is allocated with an expansion module for allocating the calculation node and the storage node.

In an embodiment of the present disclosure, the serial storage signal switch node is allocated to transmit allocation information of the calculation node and the storage node to a management device through an integrated circuit bus.

Embodiments of the present disclosure also provide a server: the server includes a cabinet server system as described above.

As described above, a cabinet server system and a server of the present disclosure have the following beneficial effects:

The present disclosure allocates a calculation node and a storage node through a serial storage signal switch node, and has a flexible configuration. Each calculation node can randomly allocate the number of hard disks according to service requirements, and the hard disks on each calculation node can be evenly allocated to multiple storage nodes to achieve load balancing while ensuring that system data is secure.

In the present disclosure, a single storage node can connect to calculation nodes through two serial storage signal switch nodes, and when one path is not functioning, the hard disks on the storage node can still be accessed.

In the present disclosure, the management of the serial storage signal switch node and the storage node does not require an additional BMC chip, and the management is performed by the serial storage signal switch node or the expansion module (expander chip) itself.

### BRIEF DESCRIPTION OF THE DRAWINGS

FIG. 1 is a schematic structural diagram of a cabinet server system including one single serial storage signal switch node according to an embodiment of the present disclosure.

FIG. 2 is a schematic structural diagram of a cabinet server system including two serial storage signal switch nodes according to an embodiment of the present disclosure.

FIG. 3 is a schematic diagram showing an interface of a serial storage signal switch node of a cabinet server system according to an embodiment of the present disclosure.

FIG. 4 is a schematic structural diagram of a storage node in a cabinet server system according to an embodiment of the present disclosure.

### DETAILED DESCRIPTION

The detailed features and advantages of the present disclosure are described in detail below in the embodiments of the present disclosure. The objects and advantages associated with the present disclosure can be readily understood by those skilled in the art. The following examples are intended to describe the present disclosure in further detail, but do not limit the scope of the invention in any way.

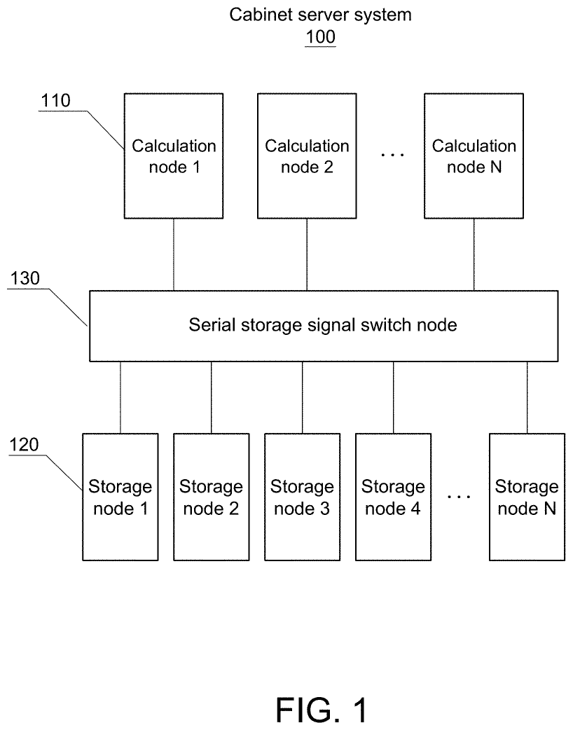

Please refer to FIG. 1 to FIG. 4. The reader should understand that the structures, the proportions, the sizes of the drawings are only used to facilitate the understanding and reading of the present disclosure, and are not intended to limit the implementation of the present disclosure, so it is not technically meaningful. Any modification of the structure, change of the proportional relationship or adjustment of the size should remain in the present disclosure when the disclosed technical content is within the scope of the disclosure and without affecting the effects and the achievable purposes of the invention. In the meantime, the terms “upper”, “lower”, “left”, “right”, “intermediate” and “one” as used in this specification are also for convenience of description, and are not intended to limit the present scope of the invention. The change or adjustment of the relative proportional relationship is also considered to be within the scope of the invention.

An embodiment of the present disclosure is to provide a cabinet server system and a server, to solve the disadvantages of inflexible cold storage configuration in the prior art.

The embodiment of the present disclosure connects the storage node and the calculation node to a serial storage signal switch node (SAS-Switch) based on a serial storage signal switch node (SAS-Switch), and enables the storage capacity of the calculation node to be arbitrarily allocated through the allocation function of the serial storage signal switch node (SAS-Switch), and the HDD of a single storage node is allocated to multiple calculation nodes, thereby reducing the risk of a single storage node being damaged.

The principle and implementation of a cabinet server system and a server in this embodiment are described in detail below, so that a cabinet server system and a server of the embodiment can be understood by those skilled in the art without any creative work.

As shown in FIG. 1, the embodiment provides a cabinet server system 100. The cabinet server system 100 includes: a plurality of storage nodes 120 and a plurality of calculation nodes 110; and at least one serial storage signal switch node 130, connected to the plurality of storage nodes 120 and the plurality of calculation nodes 110, to allocate the calculation nodes 110 and the storage nodes 120.

In this embodiment, the serial storage signal switch node 130 is a network device for electrical (optical) signal transferring, and may be allocated to provide an exclusive electrical signal path for any two networks that access the serial storage signal switch node 130.

The serial storage signal switch node 130 (Serial-attached SCSI Switch) is a commercial level switch with a storage interface that replaces parallel SCSI. The SAS switch can be directly connected to the server, and can complete the hybrid connection of multiple servers and multiple SAS disk arrays, and may overcome the limitations of one-to-one or one-to-multiple connection between the DAS server and the parallel SCSI disk array. The connection is promoted to the network level, constitutes a storage network, therefore greatly improve the sufficiency and comprehensiveness of data transmission and information exchange.

In this embodiment, the serial storage signal switch node (SAS-Switch) 130 is connected to the plurality of storage nodes 120 and the plurality of calculation nodes 110, to allocate the calculation node 110 and the storage node 120. That is, in this embodiment, both the storage node 120 and the calculation node 110 are connected to the serial storage signal switch node 130, and through the serial storage signal switch node 130, the calculation node 110 and the storage node 120 can be allocated in any way.

Therefore, the cabinet server system 100 in this embodiment is flexible in configuration, thus can lower the access frequency, minimize the storage cost, and provides flexible storage configuration for those cold materials that are accessible at any time, so that the cabinet server system 100 forms a cabinet-type cold storage system with flexible configuration of cold data.

In this embodiment, the allocation way in which the serial storage signal switch node 130 allocates the calculation node 110 and the storage node 120 will be described below.

In the embodiment, the serial storage signal switch node 130 which allocate the calculation node 110 and the storage node 120 includes: one or plurality of hard disks of the storage node which is allocated for any one of the calculation nodes.

Wherein, a hard disk (HDD) on a single storage node 120 is allocated to a plurality of calculation nodes 110, which may reduce the risk a single storage node 120 being damaged.

In this embodiment, each calculation node 110 can arbitrarily arrange the number of hard disks of the storage node 120 according to the service requirement. If the calculation node 110 allows, they can all be allocated to one calculation node 110, that is, in this embodiment, the hard disk of the plurality of storage nodes 120 may be allocated to one of the calculation nodes 110.

In the embodiment, the allocation of the calculation node 110 and the storage node 120 includes: a plurality of hard disks in the plurality of storage nodes 120 which is allocated for one of the calculation nodes 110.

The hard disk on each calculation node 110 can be evenly allocated to multiple storage nodes 120, which can achieve load balancing and ensure that the cabinet server system 100 is secure at the same time.

In this embodiment, a single storage node 120 can be connected to the calculation node 110 through two serial storage signal switch nodes 130, and when one path is not functioning, the hard disks on the storage node can still be accessed.

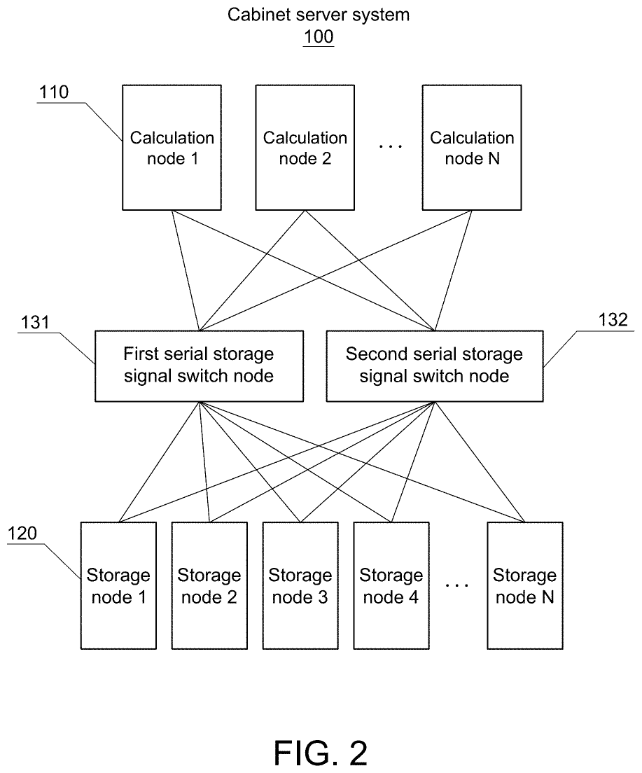

Specifically, in the present embodiment, as shown in FIG. 2, the serial storage signal switch node 130 includes a first serial storage signal switch node 131 and a second serial storage signal switch node 132.

Wherein the first serial storage signal switch node 131 is connected to the plurality of storage nodes 120 and the plurality of calculation nodes 110 respectively, and the second serial storage signal switch node 132 is also connected to the plurality of storage nodes 120 and the plurality of calculation nodes 110 respectively.

In this embodiment, the plurality of storage nodes 120 is connected to the first serial storage signal switch node 131 and the second serial storage signal switch node 132 through a dual interface data line; the plurality of calculation nodes 110 is also connected to the first serial storage signal switch node 131 and the second serial storage signal switch node 132 through a dual interface data line.

For example, each storage node 120 is connected to the first serial storage signal switch node 131 and the second serial storage signal switch node 132 via an SFF8644 cable dual interface data line, and each calculation node 110 is also connected to the first serial storage signal switch node 131 and the second serial storage signal switch node 132 via an SFF8644 cable dual interface data line.

When one of the first serial storage signal switch node 131 and the second serial storage signal switch node 132 fails, the other one can still normally maintain the paths between the calculation node 110 and the storage node 120, so that when one of the single serial storage signal switch node 130 is broken, the cabinet is still operable.

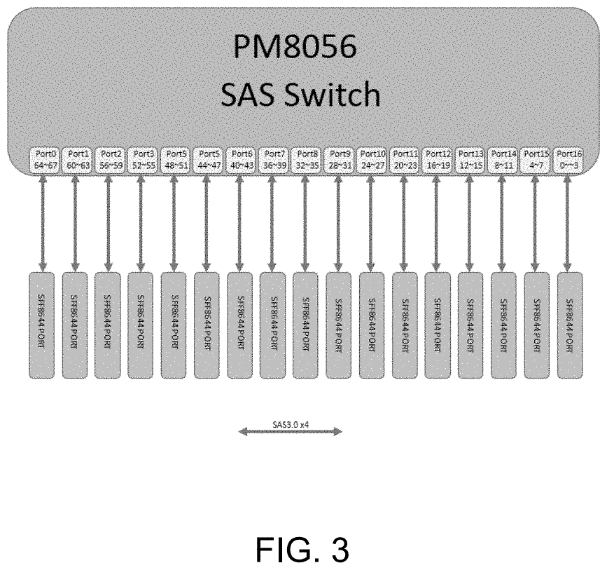

FIG. 3 is a schematic structural diagram of the serial storage signal switch node 130 in the present embodiment. The serial storage signal switch node 130, or the first serial storage signal switch node 131 and the second serial storage signal switch node 132, use, for example, a PM8056 type serial storage signal switch node (SAS-Switch).

The serial storage signal switch node 130, or the first serial storage signal switch node 131 and the second serial storage signal switch node 132, have multiple ports (Port 0 to Port 16 shown in FIG. 3), wherein each port has a dual interface.

For example, the serial storage signal switch node 130, or the first serial storage signal switch node 131 and the second serial storage signal switch node 132, use the SFF8644 interface (SFF8644PROT shown in FIG. 3) as the ports.

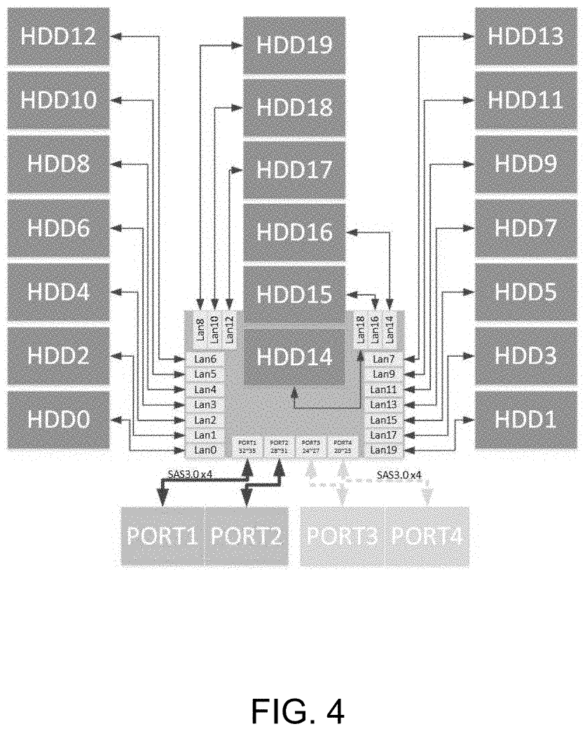

In this embodiment, as shown in FIG. 4, it is a schematic structural diagram of a single storage node 120. As seen in FIG. 4, the plurality of storage nodes 120 includes a plurality of hard disks (HDDs), such as the hard disks HDD 0 to HDD 19 shown in FIG. 4, and the hard disks are connected to the external connection of the storage node 120 (Port 1 to Port 4 shown in FIG. 4) through a local area network Lan.

In this embodiment, preferably, the plurality of storage nodes 120 is connected to both of the serial storage signal switch nodes 130, that is, the plurality of storage nodes 120 is connected to the first serial storage signal switch node 131 and the second serial storage signal switch node 132 respectively through two external connections, such as Port 1 and Port 2.

The first serial storage signal switch node 131 and the second serial storage signal switch node 132 may be allocated in the way as needed, to allocate a single or multiple HDDs of the storage node 120 to any one of the calculation nodes 110. When there is a failure in Port 1 of the secondary node, the content of this storage node 120 can be accessed through Port 2. In this way, storage nodes 120 can be flexibly allocated according to the business needs of the calculation node 110 and load balancing needs.

In addition, in the embodiment, the serial storage signal switch node 130 is allocated with an expansion module used for allocating the calculation node 110 and the storage node 120.

The expansion module includes, for example, but not limited to, an Expander chip, wherein the calculation nodes 110 and the storage nodes 120 are allocated by the Expander chip.

In this embodiment, the calculation nodes 110 and the storage nodes 120 may be allocated by the serial storage signal switch node 130, or may be allocated by the expansion module of the serial storage signal switch node 130, without additional management modules such as BMC chips for management configuration.

In the embodiment, the serial storage signal switch node 130 transmits the allocation information of the calculation nodes 110 and the storage nodes 120 to the management device through the integrated circuit bus.

For example, the serial storage signal switch node 130 or the expansion module of the serial storage signal switch node 130 directly transmits allocation information of the calculation nodes 110 and the storage nodes 120 to RMC manages devices through the I2C bus.

Embodiments of the present disclosure also provide a server that includes the cabinet server system 100 as described above. The cabinet server system 100 has been described in detail above, and would not be described below again.

In the embodiment, the server may have one cabinet server systems 100 allocated in a half cabinet, or have two cabinet server systems 100 allocated in a full cabinet.

Wherein, when there is the cabinet server system 100 in a half cabinet, the cabinet server system 100 may adopt a serial storage signal switch node 130 or two serial storage signal switch nodes 130; when there are two cabinet server systems 100 in a full cabinet, each of the cabinet server systems 100 may also adopt a serial storage signal switch node 130 or two serial storage signal switch nodes 130.

In addition, in order to highlight the innovative part of the invention, the technical features that are not closely related to solving the technical problem proposed by this invention are not introduced in this embodiment, but this does not mean that there is no other structural and functional characteristics in this embodiment.

It should be noted that the drawings provided in the present embodiment merely illustrate the basic concept of this invention in a schematic manner, and only the components related to this present invention are shown in the drawings, instead of being illustrated according to actual implementation, number, shape and size. In actual implementation. The types, quantities and proportions of the components can be changed arbitrarily, and the component layout patterns may be more complicated.

In summary, the present disclosure is about allocating a calculation node and a storage node through a serial storage signal switch node, which has a flexible configuration. Each calculation node can randomly allocate the number of hard disks according to service requirements, and the hard disk under each calculation node can be evenly allocated to multiple storage nodes to achieve load balancing, and ensuring higher security level for system data; in the present disclosure, a single storage node can connect to the calculate nodes through two serial storage signal switch nodes, and when there is a failure in one path, the hard disks on the storage node can still be accessible; in the present disclosure, the management of the serial storage signal switch node and the storage node can be completed by the serial storage signal switch node or the expansion module (Expander chip) itself, and does not require an additional BMC chip. Therefore, the present disclosure can effectively overcome various shortcomings in the prior art and has high value of industrial utilization.

What is claimed is:

1. A cabinet server system comprising:
a plurality of storage nodes;
a plurality of calculation nodes; and
at least one serial storage signal switch node, respectively connected to the plurality of storage nodes and the plurality of calculation nodes, and allocated to allocate the calculation nodes and the storage nodes.

2. The cabinet server system according to claim 1, wherein the at least one serial storage signal switch node comprises a first serial storage signal switch node and a second serial storage signal switch node, the first serial storage signal switch node is respectively connected to the plurality of storage nodes and the plurality of calculation nodes, and the second serial storage signal switch node is respectively connected to the plurality of storage nodes and the plurality of calculation nodes.

3. The cabinet server system according to claim 2, wherein the plurality of storage nodes connect to the first serial storage signal switch node and the second serial storage signal switch node through a plurality of dual interface data lines respectively, the plurality of calculation nodes connect to the first serial storage signal switch node and the second serial storage signal switch node through the plurality of dual interface data lines.

4. The cabinet server system according to claim 2, wherein allocating the calculation nodes and the storage nodes comprises:
allocating one or a plurality of hard disks of the plurality of storage nodes to any one of the calculation nodes.

5. The cabinet server system according to claim 1, wherein allocating the calculation nodes and the storage nodes comprises:
allocating a plurality of hard disks of the plurality of storage nodes to one of the calculation nodes.

6. The cabinet server system according to claim 1, wherein allocating the calculation nodes and the storage nodes comprises:
allocating a plurality of hard disks of each of the plurality of calculation nodes to the plurality of storage nodes evenly.

7. The cabinet server system according to claim 1, wherein the at least one serial storage signal switch node is allocated with an expansion module for allocating the calculation nodes and the plurality of storage nodes.

8. The cabinet server system according to claim 1, wherein the at least one serial storage signal switch node transmits a piece of allocation information for allocating the plurality of calculation nodes and the plurality of storage nodes to a management device through an integrated circuit bus.

9. A server, comprising a cabinet server system according to claim 1.

10. The server according to claim 9, wherein a half of a cabinet of the server is configured with one cabinet server system, or a whole of a cabinet of the server is configured with two cabinet server systems.
